(19) United States
(12) Patent Application Publication
(10) Pub. No.: US 2021/0091459 A1
(43) Pub. Date: Mar. 25, 2021

(54) IMPROVED ANTENNA

(71) Applicant: FESTINA LOTUS, S.A., MADRID (ES)

(72) Inventor: LIU Jian, MALMO (SE)

(21) Appl. No.: 16/499,101

(22) PCT Filed: Mar. 29, 2018
(86) PCT No.: PCT/SE2018/050346

§ 371 Date: Sep. 27, 2019

(30) Foreign Application Priority Data
Mar. 30, 2017 (SE) 1750377-2

(51) Int. Cl. H01Q 1/27; H01Q 1/38; H01Q 1/24

(52) U.S. Cl. CPC H01Q 1/273; H01Q 1/24; H01Q 1/38

(57) ABSTRACT

The present invention relates to the field of antennas, and in particular to an antenna arrangement which comprises a printed circuit board, PCB, configured to carry a transceiver, wherein the PCB is configured to be arranged within a conductive outer wall and thereby forming an antenna gap between the conductive outer wall and the PCB.

### CROSS-REFERENCE TO RELATED APPLICATIONS

The present application claims the benefit of Swedish patent application No. 1750377-2, filed on Mar. 30, 2017, incorporated herein by reference.

### TECHNICAL FIELD

The present invention relates to the field of antennas, and in particular to an antenna arrangement and a method for providing an improved antenna.

### BACKGROUND

An antenna is a kind of interface for transmitting and/or receiving information from one place to another. The antenna is an electrical device which converts electric power into electromagnetic radiation when transmitting information, and vice versa when receiving information. Electromagnetic radiation refers to the waves of the electromagnetic field, propagating (radiating) through space carrying electromagnetic radiant energy. The electromagnetic waves are synchronized oscillations of electric and magnetic fields that propagate at the speed of light through a vacuum. They include among others radio waves, which have frequencies as high as 300 GHZ to as low as 3 kHz. Any of the electromagnetic wave frequencies within that range are called radio frequency. The radio waves carry signals through the air with almost no transmission loss and thereby provide a good way for transmitting information over a distance.

Antennas are essential components of all equipment that uses radio and that wants to communicate (transmit and/or receive information/data) with another entity. They are used in systems such as radio broadcasting, mobile terminals, two-way radio, and broadcast television, as well as in other devices such as garage door openers, Bluetooth-enabled devices, smartwatches, wireless computer networks and RFID-tags on merchandise.

An antenna is designed in size in relation to the intended wavelength. The antennas are characterized by a number of performance measures which are important while selecting or designing a certain antenna for a particular application. The most important factors are the directional characteristics and the resulting gain.

Directivity is a measure of how “directional” an antenna's radiation pattern is and measures the degree to which the radiation emitted is concentrated in a single direction. Antenna gain combines the antenna's directivity and electrical efficiency and is a measure of the degree of directivity and power density of the antenna's radiation pattern. A highly directional antenna will radiate most of its power in a certain direction, while a less directional antenna will radiate its power over a wider angle. A plot of the gain as a function of direction is called the radiation pattern. Accordingly, the radiation pattern defines the variation of the power radiated by an antenna as a function of the direction away from the antenna. Furthermore, antenna efficiency is a measure of how much power that is radiated by the antenna relative to the antenna input power.

When mechanical designing an antenna, the purpose of the antenna has to be specified first as some types of antennas are more suitable for certain applications. Also the general environment of the antenna has to be specified in terms of surrounding components and material property, because this will also affect the performance measures. For example, metal is a conductor of electricity and magnetism, and so it absorbs radio waves and transforms radiation pattern. Accordingly, a surrounding that includes a lot of metal will heavily affect the antenna and has to be considered, and dealt with, when designing the antenna.

In the 1970s the first digital watch was launched. Since then, the development of the wristwatches have continued. From, at the beginning, including a simple digital display and maybe also a calculator, up to smartwatches that were first launched in the late 1990s. A smartwatch is a computerized wristwatch with functionality that goes beyond timekeeping and with the ability to communicate with other entities.

However, in order to include communications possibilities within a wristwatch (or smartwatch), or for that matter in any other communications device, at least one antenna has to be included. In order to get the best possible conditions for communication, the watch (or device) has to be designed after the antenna, where the antenna type and design are chosen with regard to the desirable performance measures. Accordingly, the antenna design and performance have to be secured first in order to achieve the wanted result of the communication. As the antenna has to be prioritized, the watch or device thus has to be designed in dependence of the antenna. This introduces limitations to the design possibilities of the final product (the watch or the device). These limitations are both with regards to the shape and size of the device, as well as with regards to the construction materials of the device.

### SUMMARY

The use of antennas has dramatically increased in recent years. In the early 1900s there were only a few antennas in total in the world, today there are even more antennas than persons. The use of antennas seems to continue to grow and in the future it is expected to be more antennas than objects, where objects include for example all electronic devices in e.g. our homes, work places and stores. It is expected that almost all kind of objects will include at least one antenna, probably more.

In respect to the above, the inventor of the present invention has realized that there are problems with existing antennas, there are no antennas that are efficient enough to be capable of transmitting and receiving radio signal over all of the desired performance and that in the same time is made with extreme simplicity, and flexibility, with a minimum number of parts.

One problem to be solved or at least mitigated by the present invention is to make an efficient antenna that is made very simple, with minimum number of parts and a lot of flexibility for antenna implementation.

This problem is according to a first aspect solved by providing an antenna arrangement which comprises a printed circuit board, PCB, configured to carry a transceiver, wherein the PCB is configured to be arranged within a conductive outer wall and thereby forming an antenna gap between the conductive outer wall and the PCB.

In one embodiment the antenna arrangement further comprises a feed arranged to connect the transceiver with the conductive outer wall. In one embodiment a coupling element of the feed is realized with a conductive sheet.

In one embodiment the antenna arrangement comprises the conductive outer wall. In one embodiment the conductive outer wall is made of metal.

In one embodiment the antenna arrangement comprises a lid and wherein there is a lid gap between the lid and the conductive outer wall. In one embodiment the lid is of metal. In one embodiment the lid is a dial plate.

In one embodiment the antenna arrangement comprises a back cover. In one embodiment the back cover is of metal.

In one embodiment the PCB comprises a ground plane.

In one embodiment a circumference of the antenna gap is half of the wavelength of resonance frequency.

In one embodiment a matching circuit is placed in between the transceiver and the radio frequency feed.

In one embodiment the antenna arrangement further comprises at least two grounding springs arranged to connect the PCB to the conductive outer wall and thereby providing at least one active area and at least one inactive area in the antenna gap.

In one embodiment the antenna arrangement is to be enclosed within a smartwatch.

The present application further provides a smartwatch comprising an antenna arrangement according to the described embodiments.

The present application also provides a method for providing an antenna arrangement, wherein said method comprises providing a PCB configured to carry a transceiver and configured to be arranged within a conductive outer wall, thereby forming an antenna gap between the conductive outer wall and the PCB.

The present application also provides a method for providing an antenna arrangement, wherein said method comprises arranging a PCB configured to carry a transceiver within a conductive outer wall thereby forming an antenna gap between the conductive outer wall and the PCB.

The inventor of the present invention has further realized, after inventive and insightful reasoning, that by constructing an antenna by redesigning a prior art slot antenna in a clever way by stretching the slot and connecting the two slot ends in order to form a composite gap, where the gap forms the antenna, an efficient and flexible antenna will be provided. This antenna is also simple in design. The antenna arrangement will be provided with an inner surface and an outer wall, where the outer wall could be used as a casing which also shields the product including the antenna itself. The antenna arrangement is light weight, takes up a minimum of space and is cheap to produce. The proposed arrangement also provide for shock absorbing properties which are highly beneficial for body worn devices.

The teachings herein find use in any device that uses antennas for transmitting and receiving data, such as in devices as e.g. Bluetooth-enabled devices, pocket watches, desk clocks, speaker boxes with metal casings and wearable devices such as e.g. wristwatches, bracelets and pendants.

Other features and advantages of the disclosed embodiments will appear from the following detailed disclosure, from the attached dependent claims as well as from the drawings. Generally, all terms used in the claims are to be interpreted according to their ordinary meaning in the technical field, unless explicitly defined otherwise herein.

All references to the terms “antenna,” “antenna system”, and “antenna arrangement” are to be interpreted openly as referring to any device or system that incorporates a single element, multiple elements, or one or more arrays of elements that receive and/or transmit and/or propagate one or more frequency bands of electromagnetic radiation.

All references to “a/an/the [element, device, component, means, etc.]” are to be interpreted openly as referring to at least one instance of the element, device, component, means, etc., unless explicitly stated otherwise.

### BRIEF DESCRIPTION OF THE DRAWINGS

The invention is described in the following with reference to the accompanying drawings, in which

FIG. 1 shows a simplified antenna arrangement according to the invention.

FIG. 2 shows a simplified embodiment of two communicating antenna arrangements.

FIGS. 3A and 3B show an embodiment of an antenna arrangement according to the invention.

FIG. 4 shows an antenna arrangement where the feed is realized with a conductive sheet.

FIG. 5 shows an antenna arrangement, where the feed is realized with a conductive sheet, where the antenna arrangement is to be placed within a casing.

FIG. 6 shows an antenna arrangement with a lid.

FIG. 7 shows an antenna arrangement with radiation windows at both ends.

FIG. 8 shows a wearable device such as a smartwatch which comprises an antenna arrangement.

FIG. 9 shows a flowchart for a general method of providing an antenna arrangement.

### DETAILED DESCRIPTION

The enclosed embodiments will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout.

FIG. 1 generally shows a simplified antenna arrangement (100) to be arranged in a conductive outer wall (10) according to an embodiment herein. The antenna arrangement (100) comprises a transceiver (30) which transmits or receives and/or propagates electromagnetic radiation. A transceiver can work as both transmitter and receiver and can accordingly both receive or transmit signals. The transceiver (30) can be designed in several ways depending on the desired requirements. In one embodiment, the transceiver (30) is replaced by element/s with solely receiving capability. In one embodiment, the transceiver (30) is replaced by element/s with solely transmitting capability. By replacing the transceiver by solely receiving or transmitting elements, an antenna arrangement with a single focus (sending or receiving capability) is obtained.

In transmission, the transceiver (30) supplies an electric current oscillating at radio frequency (i.e. a high frequency alternating current (AC)) and the antenna radiates the energy from the current as electromagnetic waves. In reception, the antenna intercepts some of the power of an electromagnetic wave in order to reproduce a weak signal, which is applied to the transceiver (30) to be amplified and processed.

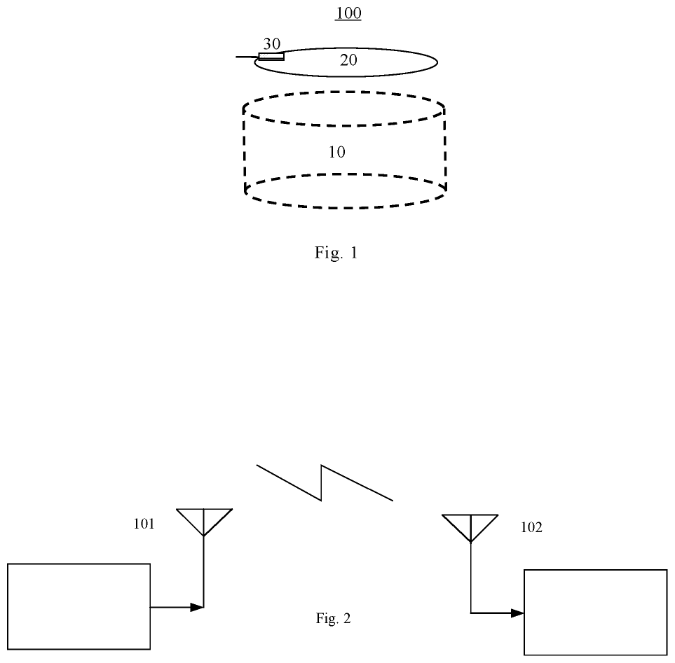

The radiation from, and to, the antenna arrangement (100) have wavelengths in the electromagnetic spectrum longer than infrared light. The waves have frequencies from as low as 3 kHz up to as high as 300 GHz and the antenna arrangement could work for different radio applications like GPS, Bluetooth, WIFI, ANT, cellular, etc. The radio waves may be transmitted from one location to another location where one or more of the locations may be mobile, stationary and/or fixed to a location such as for example a base station possibly fixed to the ground. FIG. 2 shows a simplified embodiment of how two mobile devices including antenna arrangements (101, 102) could communicate with each other. In FIG. 2, the antenna arrangement (101) transmits a signal/information to antenna arrangement (102), which receives the signal/information.

The transceiver (30) of the antenna arrangement (100) is connected to a printed circuit board, PCB (20) which comprises a ground plane. A printed circuit board, PCB, is a board used in electronics and is found in all electronic products. The PCB (20) mechanically supports and electrically connects electronic components using transmission lines, pads and other features etched from for example copper sheets laminated onto a non-conductive substrate such as for example Teflon, ceramics, fiber glass and special polymers. The PCB (20) could be of a very simple design carrying just one or a few components or be more complex with multiple components. Depending on the use and the number of components, the PCB (20) could be single sided (one copper layer), double sided (two copper layers) or multi-layer (outer and inner layers). On the PCB (20) a large area or layer of copper foil that is connected to the circuit's ground point, usually one terminal of the power supply, forms the ground plane. The ground plane serves as the return path for current from many different components.

Thus, due to the variable and flexible design and functionality of a PCB (20), it is advantageous to use the function of a PCB (20) in the antenna arrangement (100). The PCB (20) could at the same time be used for several other purposes in addition to the antenna. The antenna arrangement (100) according to the present invention thus makes it possible to provide a solution to the problem of how to make a simple antenna arrangement (100) without the need of several extra components when the antenna arrangement (100) is combined with a device with other functionalities.

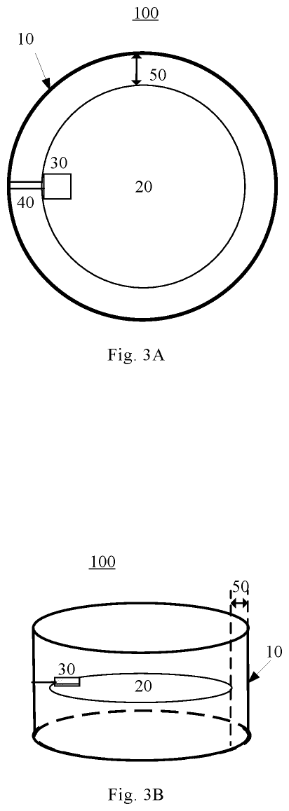

In one embodiment, a conductive outer wall (10) surrounds the PCB (20), which is illustrated in FIGS. 3A and 3B. As seen in FIGS. 3A or 3B, a conductive outer wall (10) surrounds the PCB (20) which is thus contained within the conductive outer wall (10). Accordingly, the conductive outer wall (10) provides protection against the outside environment for the PCB (20). The material of the conductive outer wall (10) defines the kind of protection it provides.

The conductive outside wall (10) may for example provide protection against external disturbances. The conductive outer wall (10) will act as a physical shield for preventing the antenna arrangement (100) to be affected by disturbances such as for example shocks, water and dirt.

The conductive outer wall (10) is of metal, but could include any conductive material. The conductive outer wall (10) may be of metals such as for example stainless steel, silver, gold and titanium. Outside of the conductive outer wall (10) additional layer/s of material/s could be added. The outside of the conductive outer wall (10) is then surrounded by another material. That material could be another metal, but could include any other material such as for example plastic or textiles.

In the FIGS. 3A and 3B, the conductive outer wall (10) and the PCB (20) are circular, but the shape of the conductive outer wall (10) and the PCB (20) could for example be triangular, rectangular, or irregular. The conductive outer wall (10) and the PCB (20) could have any shape as long as the PCB (20) is fitted inside and the antenna arrangement (100) of this invention, and is therefore highly adaptable. In one embodiment the conductive outer wall (10) is a casing. Since the invention makes it possible to choose among many materials and shapes for the antenna arrangement (100), the invention provides a solution to the problem of how to make an antenna arrangement with a lot of flexibility for fulfilling various design criteria and requirements.

Between the conductive outer wall (10) and the PCB (20) is a gap (50). The gap is filled with air or any non-conductive material, gas or vacuum. The gap (50) between the PCB (20) and the conductive outer wall (10) creates the radiation and forms the antenna. By controlling the size and dimension of the antenna gap (50) the frequency which the antenna arrangement (100) resonates at will be controlled or determined.

In one embodiment the PCB (20) has an extension, such as diameter, width and/or length that is smaller than the corresponding extension of the conductive outer wall (10). The difference in extension will be the size of the resulting antenna gap (50) being formed as the PCB (20) is inserted into or otherwise arranged within the conductive outer wall (10).

The relation between the wavelength of the antenna λ, the conductive outer wall (10) and the antenna gap (50) could be expressed as;

λ=(C+W)/2,

where C is the circumference of the inner surface of the conductive outer wall (10) and W is the size of the antenna gap (50). Therefore, when the antenna gap (50) is big it needs to be considered in the wavelength and resonance frequency calculations, while when the antenna gap (50) is small it can be negligible.

Furthermore, the width of the antenna gap (50) is related to the bandwidth of the antenna arrangement (100). The wider the antenna gap (50) is, the bigger the bandwidth will be. The bandwidth requirement is different depending on the application. For example. Bluetooth radio bandwidth is around 245 MHZ, while for GPS, the bandwidth is less than 2 MHz.

The space directly above or under the gap (seen from the same level as the PCB (20)) is required to have good clearance within certain distance in vertical direction to maintain a suitable radiative efficiency. Any metallic or lossy object inside, above or underneath the antenna gap (50) may create loss and detuning to the antenna arrangement (100) depending on the size and electrical property of the object. Accordingly, any metallic or lossy object that blocks the radiation path within the antenna arrangement (100) or protrudes into the antenna gap (50) will potentially affect the radiative efficiency and radiation pattern. Viewing from the PCB (20) and antenna gap (50), the upper part and lower part of the device are symmetrical. The height of the conductive outer wall (10) does not affect the resonance of the antenna arrangement (100), but relates to the directivity of the radiation pattern. The higher/taller the conductive outer wall (10) are, the more directional the antenna arrangement (100) will get.

In order to better understand the present invention, an antenna arrangement with a conductive outer wall (10), a PCB (20) and an antenna gap (50) could be seen as a highly modified slot antenna. The slot antenna is formed by the antenna gap (50) corresponding to and acting as the antenna gap (50) and the conductive outer wall (10) corresponding to and acting as the body of the slot antenna.

In one embodiment the antenna arrangement (100) further includes a feed (40). The antenna feed (40) refers to all the components of the antenna which feed the radio waves to the rest of the antenna arrangement, or in a receiving mode collect the incoming radio waves, convert them to electric currents and transmit them to the receiver. Accordingly, the feed refers to any energy conductor and coupling element(s) that can transfer energy, transform impedance, enhance performance characteristics, and conform impedance properties between an incoming or outgoing radio frequency signals to that of one or more connective elements, such as for example a radiator. The feed connects the transceiver (30) with the conductive outer wall (10).

In one embodiment, the feed (40) is a direct feed, which is in physical contact with the conductive outer wall (10).

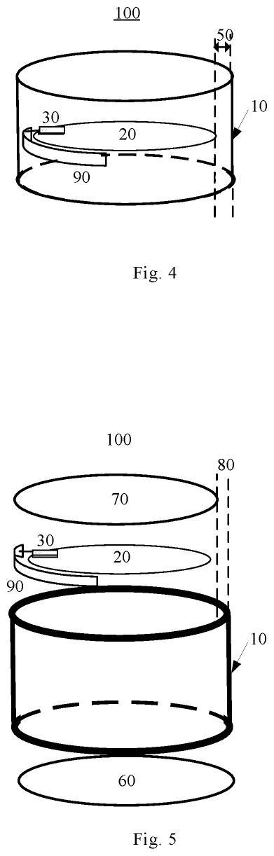

In one embodiment, the coupling element of the feed (40) is realized with a sheet of a conductive material, a conductive sheet (90), see FIG. 4. The conductive sheet (90) is put close to, but not in physical contact with, the conductive outer wall (10). By this antenna arrangement (100), the conductive sheet (90) could be used to avoid dedicated mechanical features, such as springs or other physical contacting components, in the conductive outer wall (10) for feed connection. This will reduce manufacturing costs and make different case designs easily compatible with the antenna arrangement (100) as long as the internal dimensions are identical in the different designs. Accordingly, an antenna arrangement (100) comprising a PCB (20) carrying a transceiver (30) could be placed within any case design, or conductive outer wall (10) design, which can have any size and shape, as long as the internal structure is the same, as can be seen in FIG. 5.

By the herein described elements of the antenna arrangement (100) according to the invention, the provided antenna arrangement (100) is made very simple with minimum number of parts, but still with a lot of flexibility for antenna implementation. Since the shape of the antenna arrangement (100), i.e. the antenna gap (50) and the conductive outer wall (10), can be varied, it is possible to make the antenna arrangement (100) in any desirable size and form. Accordingly, the device using the antenna arrangement (100) could be made in any desirable size and form and the complexity, size and clearance requirement of the antenna arrangement (100) does not limit the possibility of designing a device in a desirable size and form and the antenna arrangement may fulfill a wide range of design requirements.

Furthermore, while the antenna arrangement (100) is simple and flexible, the antenna is efficient enough to be capable of transmitting and receiving radio signal over all of the desired performance. Surface current is concentrated at the feed (40) and diagonal areas along the edge of PCB (20) ground plane, as well as on the inner surface of the outer circumference in parallel to PCB (20). Due to the depth or height of the conductive outer wall (10), the radiation pattern of the whole antenna arrangement is regulated into a beam with relatively high directivity and which is vertically polarized.

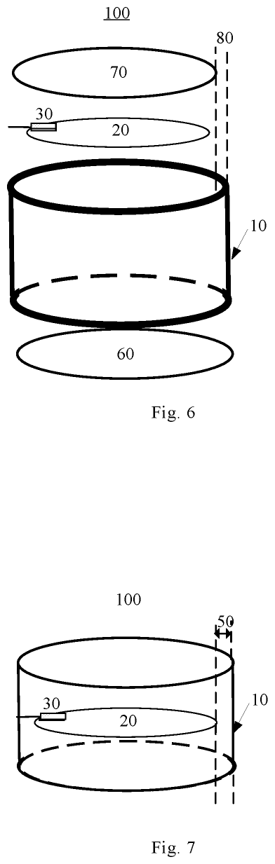

The inventor has further realized that with the present antenna arrangement (100), it is also possible to cover the antenna arrangement (100) with a metallic lid (70) without impairing or reducing the antenna efficiency. This solves the problem of how to enclose an antenna arrangement (100) within a device, such as a watch, a speaker or an activity bracelet. The antenna arrangement (100) with a lid (70) is illustrated in FIG. 6.

By building the antenna arrangement (100) according to the present invention around the PCB (20), makes this particular antenna arrangement (100) insensitive to metallic or lossy objects covering the top of the PCB (20) within certain distance and area, which makes it possible to enclose the antenna arrangement (100) within a device.

The lid (70) could be of any shape or size as long as the lid (70) leaves one or more openings, or radiation windows, between the lid and the conductive outer wall (10). The radiation windows are where the radiation can exit or enter into the antenna arrangement (100). Accordingly, one or more open slots, or lid gaps (80), between the lid (70) and the conductive outer wall (10) may be maintained. One example of a lid gap (80) is illustrated in FIG. 6. The size of the lid gap(s) (80) could be varied depending on the resonance frequency, but will be at least 0.5 mm.

The lid (70) could have any function or design and be of any material. In one embodiment the lid (70) is of metal, for example stainless steel, silver, gold or titanium. The lid (70) could be a plain lid with no functionality other than covering the antenna arrangement (100) or the lid (70) could have functions such as for example displaying information, receiving user input or provide a sensor (for example a solar cell). According to one embodiment, the lid (70) is a dial plate which makes it possible to enclose the antenna arrangement (100) within a watch, such as for example a pocket watch or a desk clock. According to another embodiment, the lid (70) is a metallic surface which encloses the antenna arrangement within a speaker box. In still another embodiment, the lid (70) comprises an output device, for example a digital display, touch panel, driver/FPC module like LCD, OLED or an E-ink display etc.

It has further been realized by the inventor that another problem that could be solved by the present invention is when the antenna arrangement is configured to be worn by a user.

When an antenna arrangement comes near a human body, the radio waves will be affected by absorption, the resonance frequency of the antenna will shift due to coupling to human body and as result the antenna efficiency and radiation level will go down. These problems are known as body loss and detuning. Many have attempted to create a wearable device, such as for example a connected wristwatch, with an antenna inside a casing. However, these attempts have been generally unsuccessful or at least limited in their efficiency and power consumption. One of the reasons is that the complexity, size and clearance requirements of existing antenna designs compromised and limit the possibility of designing an aesthetically pleasing housing in desirable size and form.

When the antenna arrangement (100) have a radiation window (50) at both ends, see FIG. 7, the radiation/signal will be transmitted and received from both the top and bottom side of the device. This forms a multi-directional radiation pattern. However, if the antenna arrangement is to be worn by a user, with the bottom side against the body, there are significant benefits of having the bottom window sealed. This will prevent the radio signal to come out from the bottom side and be affected by the body. Instead, the radio signal will only come out from the top side of the arrangement (100). Since the antenna arrangement (100) according to the invention is arranged the inventive manner disclosed herein, it is possible to provide it with a back cover (60) without affecting its performance and the problem with body loss will be reduced. The back cover (60) is directly connected with the conductive outer wall (10).

In one embodiment, the back cover (60) is made of metal such as for example stainless steel, silver, gold and titanium. The metallic back cover (60) provides a constant reference plane for the antenna in lower part of the device. This will eliminate antenna detuning and performance variation caused by wearing (antenna coupling to wrist) and accordingly solve the problem of body loss. Thereby the present antenna arrangement (100) makes it is possible to design an efficient antenna capable of transmitting and receiving radio signal over all of the desired performance (connection quality and working distance etc.) in a wearable device with a large amount of metallic material coverage.

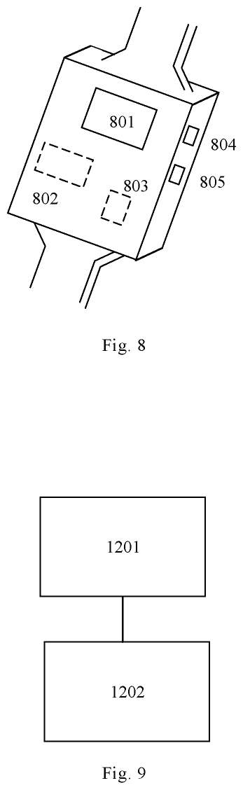

In one embodiment the antenna arrangement (100) comprises a PCB (20) carrying a transceiver (30) within a conductive outer wall (10). A feed (40) connects the transceiver with the conductive outer wall (10). The antenna arrangement (100) further comprises both a lid (70) and a back cover (60), as illustrated in for example FIG. 5 or 6, and is enclosed within a wearable device. The wearable device could be a connected wristwatch or a smartwatch, see FIG. 8, with the antenna within the housing. In one embodiment the wearable device is an activity bracelet with a display and an antenna underneath the display. Since the antenna in the described embodiments is located inside the conductive outer wall (10) and is isolated from the surrounding environment, cosmetic finish and attaching arrangement for e.g. a wrist band has no impact on the antenna performance. Furthermore, the material of the wrist band has also no impact on the antenna performance.

In one embodiment, in order to achieve minimum or reduced loss and a more effective radiation, the metallic back cover (60) is preferably arranged a few millimeters, for example 1 mm (with approximately a couple of dB efficiency degradation compared to 2 mm), away from the antenna gap (50).

In one embodiment the antenna arrangement (100) comprises a PCB (20) carrying a transceiver (30) within a conductive outer wall (10). A feed (40) connects the transceiver with the conductive outer wall (10). The antenna arrangement (100) further comprises a conductive outer wall (10), a lid (70) and a back cover (60) that are all made of metal. The metal may for example be stainless steel, gold, silver or titanium. The conductive outer wall (10) and the back cover (60) are screwed together and electrically shortened and by this construction, the antenna arrangement (100) has a metal housing which works as one conductive element. Accordingly, the antenna arrangement (100) is isolated from the environment surrounding lower part of the device and immune against loss and detuning due to wearing, while still providing an antenna arrangement (100) with an improved antenna efficiency, with a stable and high peak gain and a more concentrated beam compared to other antenna arrangements known in the art. With the disclosed antenna arrangement (100), the problem of how to provide an antenna arrangement within a metal construction is solved.

The antenna arrangement (100) according to the invention is energy efficient and thereby the need for charging capabilities is reduced. A device with the antenna arrangement (100) according to the invention will not increase its power consumption and may therefore not need rechargeable batteries and hence the need for e.g. bulky charger contacts is reduced.

A further problem that is solved by the present invention is how to, in an easy way, tune the antenna arrangement to operate at a desired frequency range. As the electromagnetic waves travel through the different parts of the antenna arrangement it may encounter differences in impedance. At each interface, depending on the impedance match, some fraction of the waves' energy will reflect back to the source.

Accordingly, by minimizing the impedance differences at each interface (impedance matching) the power transfer through each part of the antenna arrangement will be maximized and the signal reflection will be minimized. This could be achieved by placing a matching circuit in between the transceiver (30) and the feed (40). Then, the resonance could be tuned to the wanted frequency, and thus, the above mentioned problem is solved. The matching circuit may consist of discrete inductors and capacitors and could also add additional resonances to the antenna and thus make it more broadband.

In one embodiment, the problem of tuning the antenna could be solved or reduced by placing grounding connections between the conductive outer wall (10) and the PCB (20) ground plane depending on the tuning frequency. This could be performed with or without serial elements. The effect of this is equivalent to altering the circumference of antenna gap as well as resonance frequency. For fine tuning purpose a serial capacitor or inductor could be used. By using a serial electrostatic discharge (ESD) component or inductor (high inductance/rating) ESD protection regarding discharge from conductive outer wall (10) to PCB (20) ground could also be provided.

In one embodiment, the problem of tuning the antenna is solved or reduced by controlling the dimension of the conductive outer wall (10) and the PCB (20) ground plane which will decide at which frequency the antenna will resonate. This is performed by setting the maximum circumference of the antenna gap to equal half the wavelength of the wanted resonance frequency. The width of the antenna gap is negligible if the gap is significantly smaller than the circumference.

Yet a further problem that is solved by the present invention is how to obtain the possibility to contain metallic or lossy objects within the antenna arrangement which are isolated from active antenna areas.

In one embodiment, the problem above is solved or reduced by applying at least two grounding springs for splitting the antenna gap into active and inactive areas. The grounding springs are arranged to connect the PCB (20) to the conductive outer wall (10) and thereby providing at least one active area and at least one inactive area in the antenna gap (50). By dividing the antenna arrangement into active and inactive areas, it becomes possible to contain metallic or lossy objects within the antenna arrangement which are isolated from active antenna areas. As a further effect, the ground springs could also work as ESD protection.

The present application also includes a smartwatch which comprises an antenna arrangement (100), as illustrated in for example FIG. 8. The smartwatch comprises output device(s) (801) such as display and/or dial with clock hands and input device(s) (804, 805) such as buttons. The smartwatch further comprises a PCB (802) that carries a controller for controlling the operation of the smartwatch and a radio frequency interface (803) comprising an antenna arrangement according to the present invention for connecting to other devices.

The present application also includes a method for providing an antenna arrangement (100) according to the invention. FIG. 9 shows a flowchart for a general method of providing a PCB (20) to be arranged in an antenna arrangement (100) according to the invention and also for a general method for providing said antenna arrangement, said methods comprising providing (1201) a PCB (20) configured to be arranged (1202) in a conductive outer wall (10) thereby forming an antenna gap (50).

The invention has mainly been described above with reference to a few embodiments. However, as is readily appreciated by a person skilled in the art, other embodiments than the ones disclosed above are equally possible within the scope of the invention, as defined by the appended patent claims.

1. Antenna arrangement (100) comprising
a printed circuit board, PCB, (20) configured to carry a transceiver (30), wherein the PCB (20) is configured to be arranged within a conductive outer wall (10) thereby forming an antenna gap (50) between the conductive outer wall (10) and the PCB (20).

2. The antenna arrangement (100) according to claim 1, further comprising a feed (40) arranged to connect the transceiver (30) with the conductive outer wall (10).

3. The antenna arrangement (100) according to claim 2, where a coupling element of the feed (40) is realized with a conductive sheet (90).

4. The antenna arrangement (100) according to claim 1, comprising the conductive outer wall (10).

5. The antenna arrangement (100) according to claim 4, wherein the conductive outer wall (10) is made of metal.

6. The antenna arrangement (100) according to claim 1, wherein the antenna arrangement (100) comprises a lid (70) and wherein there is a lid gap (80) between the lid (70) and the conductive outer wall (10).

7. The antenna arrangement (100) according to claim 6, wherein the lid (70) is of metal.

8. The antenna arrangement (100) according to claim 6, wherein the lid (70) is a dial plate.

9. The antenna arrangement (100) according to claim 1, wherein the antenna arrangement (100) comprises a back cover (60).

10. The antenna arrangement (100) according to claim 9, wherein the back cover (60) is of metal.

11. The antenna arrangement (100) according to claim 1, wherein the PCB (20) comprises a ground plane.

12. The antenna arrangement (100) according to claim 1, wherein a circumference of the antenna gap (50) is half of the wavelength of resonance frequency.

13. The antenna arrangement (100) according to claim 1, wherein a matching circuit is placed in between the transceiver (30) and the radio frequency feed (40).

14. The antenna arrangement (100) according to claim 1, further comprising at least two grounding springs arranged to connect the PCB (20) to the conductive outer wall (10) thereby providing at least one active area and at least one inactive area in the antenna gap (50).

15. The antenna arrangement (100) according to claim 1, wherein the antenna arrangement (100) is to be enclosed within a smartwatch.

16. Smartwatch comprising an antenna arrangement (100) according to claim 1.

17. Method for providing an antenna arrangement (100), said method comprising providing a printed circuit board, PCB, (20) configured to carry a transceiver (30) and configured to be arranged within a conductive outer wall (10) thereby forming an antenna gap (50) between the conductive outer wall (10) and the PCB (20).

18. Method for providing an antenna arrangement (100), said method comprising arranging a printed circuit board, PCB, (20) configured to carry a transceiver (30) within a conductive outer wall (10) thereby forming an antenna gap (50) between the conductive outer wall (10) and the PCB (20).
